(19) United States
(12) Patent Application Publication
(10) Pub. No.: US 2003/0133703 A1
(43) Pub. Date: Jul. 17, 2003

(54) Storage device for fixing business cards and camera

(75) Inventors: Chin-Yu Lin, Taipei (TW); Chin-Wen Yang, Banchiau City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENO CORPORATION

(21) Appl. No.: 10/342,891

(22) Filed: Jan. 14, 2003

(30) Foreign Application Priority Data
Jan. 17, 2002 (TW) 91200363

(51) Int. Cl. G03B 15/00

(52) U.S. Cl. 396/3

(57) ABSTRACT

A storage device for fixing business cards and a camera. The device includes a box for storing an object, a first fixing device connected to the box for fixing the object, and a second fixing device connected to the box, having a predetermined distance from the first fixing device, for fixing a camera. The box is a business card holder or a camera case.

### BACKGROUND OF THE INVENTION

1. Field of the Invention

The present invention relates in general to a storage device for fixing business cards and a camera when the user takes photographs of the business cards.

2. Description of the Related Art

Referring to FIG. 1, a conventional business card holder includes a cover 10 and a hollow body 12 hinged together. The user puts business cards in the hollow body 12 and closes the cover 10 in direction A to protect the business cards.

When the user has a large number of business cards, space is required. Some people use computers to store and manage the business cards instead. Conventionally, people input the information on the business cards into computers by typing. However, this is time-consuming.

The present invention provides a device for storing business cards, and helps the user take photographs of the business cards. Then, the user uses a computer to process the image of the photographs, transforming the image into codes for application software. The user is able to more easily manage the information on the business cards.

### SUMMARY OF THE INVENTION

An object of the present invention is to provide a device ordinarily for storing business cards, and also for fixing a camera and a business card when the user takes a photograph of the fixed business card.

The device of the present invention includes a box for storing business cards, having a first fixing device connected to the box for fixing one of the business cards, and a second fixing device connected to the box, a predetermined distance from the first fixing device, for fixing a camera. The distance between the camera and the business card is fixed. When the business card is replaced with another one, the distance remains unchanged. Therefore, the user is able to rapidly change the business cards and take photographs without adjusting the focal distance.

### BRIEF DESCRIPTION OF THE DRAWINGS

The present invention can be more fully understood by reading the subsequent detailed description and examples with references made to the accompanying drawings, wherein:

FIG. 1 depicts a conventional business card holder;

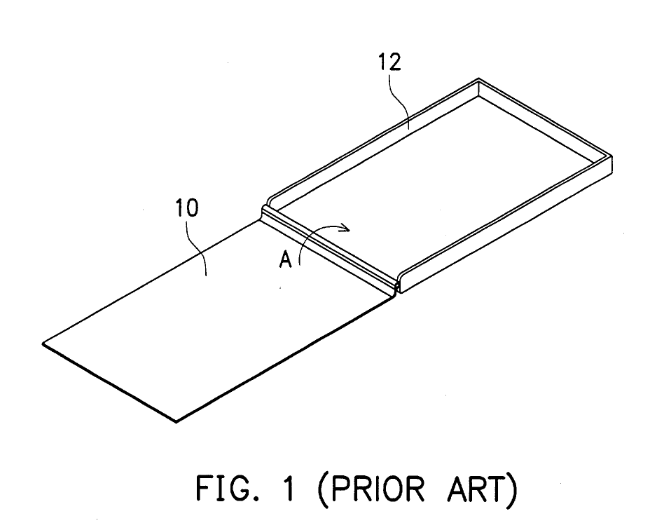

FIG. 2 depicts a business card holder in accordance with the present invention;

FIG. 3 depicts a business card fixed by the business card holder of the present invention for photographing; and

FIG. 4 depicts a business card and a camera fixed to the business card holder of the present invention for photographing.

### DETAILED DESCRIPTION OF THE PREFERRED EMBODIMENT

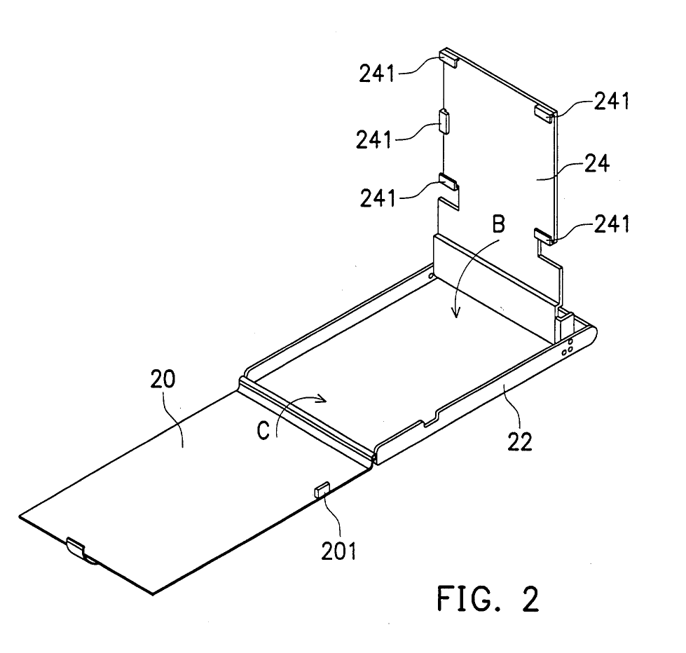

Referring to FIG. 2, a business card holder of the present invention is ordinarily used for storing business cards, and also for fixing a camera and a business card when the user takes a photograph of the business card. The business card holder of the present invention includes a cover 20, a middle plate 24 and a hollow body 22. The cover 20 and the hollow body 22 are hinged together, while the middle plate 24 and the hollow body 22 are hinged together. Business cards are disposed in the business card holder of the present invention in accordance with the following steps: Business cards are disposed in the hollow body 22. Then, the middle plate 24 is rotated in direction B to cover the business cards in the hollow body 22. Then, the cover 20 is rotated in direction C to cover the middle plate 24.

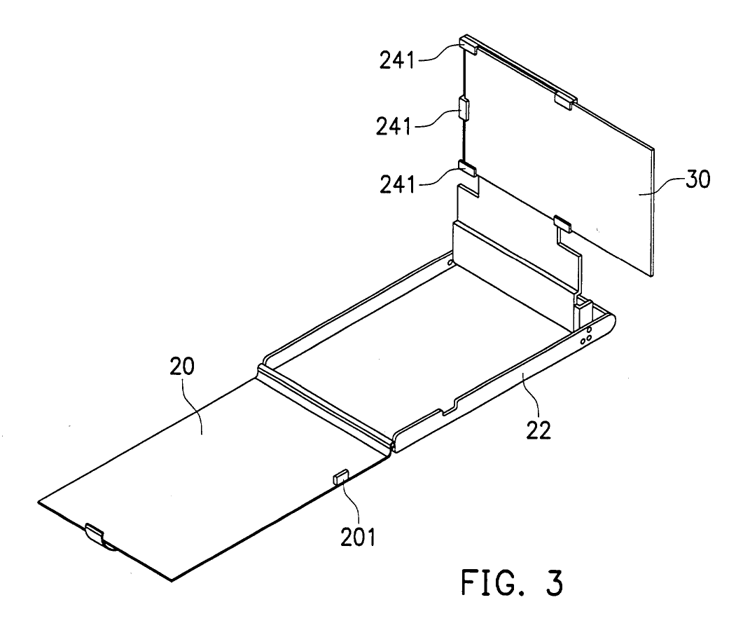

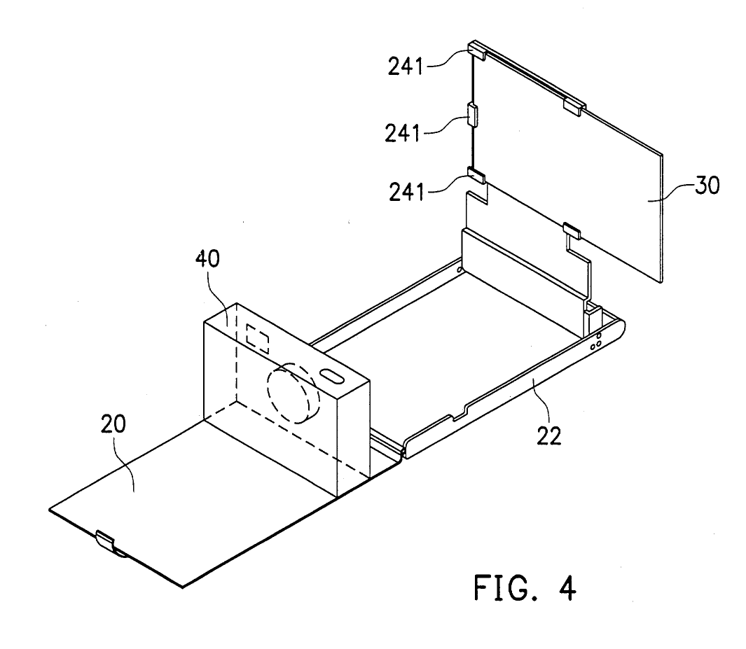

The middle plate 24 has a plurality of hooks 241 at its edges, while the cover 20 has a protrusion 201 at its edge. The user takes photographs of business cards in accordance with the following manner: Referring to FIG. 3, the user puts a business card 30 on the middle plate 24, with the business card 30 held by the hooks 241. Referring to FIG. 4, a camera 40 has a hole (not shown) to fix with a tripod on its bottom. The user puts the camera 40 on the cover 20, with the protrusion 201 of the cover 20 fitting into the hole of the camera 40, and thus the camera 40 is fixed. Then, the user can take a photograph of the business card 30.

It is understood that the distance between the camera and the business card is fixed. When the business card is replaced with another, the distance remains unchanged. Therefore, the user is able to rapidly change the business cards and take photographs without adjusting the focal distance.

It is also understood that a camera case is adapted for the present invention. The camera case of the present invention is ordinarily used for storing a camera. Also, the camera of the present invention is provided with plural hooks and a protrusion to fix the business cards and the camera when photographs are taken. Therefore, the present invention can be considered as a combination of a storage device and a fixing device.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for storing an object and fixing a camera and the object, the camera having a hole, the device comprising:
a box for storing the object;
a first fixing device connected to the box for fixing the object;
a second fixing device connected to the box, having a predetermined distance from the first fixing device, for fixing the camera.

2. A device as claimed in claim 1, wherein the box comprises a hollow body for storing the business cards, a cover hinged to the hollow body, and a plate hinged to the hollow body, and the first fixing device is connected to the plate.

3. A device as claimed in claim 2, wherein the first fixing device comprises a plurality of hooks connected to edges of the plate.

4. A device as claimed in claim 2, wherein the second fixing device is a protrusion on the cover, and the protrusion is disposed in the hole to fix the camera.

5. A method of taking photographs, comprising the steps of:
providing a box, a camera and an object;
fixing the camera and the object to the box; and
taking a photograph of the object.

6. A method of taking photographs as claimed in claim 5, wherein the box comprises a first fixing device to fix the object, and a second fixing device to fix the camera.

7. A method of taking photographs as claimed in claim 6, wherein the first fixing device comprises a plurality of hooks holding the object.

8. A method of taking photographs as claimed in claim 6, wherein the second fixing device is a protrusion, the camera has a hole, and the protrusion is disposed in the hole to fix the camera.

9. A method of taking photographs as claimed in claim 5, wherein the box is a business card holder.

10. A method of taking photographs as claimed in claim 5, wherein the box is a camera case.

11. A method of taking photographs as claimed in claim 5, wherein the object is a business card.
